(19) United States
(12) Patent Application Publication
(10) Pub. No.: US 2025/0252383 A1
(43) Pub. Date: Aug. 7, 2025

(54) SELF-SERVICE DATA QUALITY CONTROL FOR INCOMING AND OUTGOING DATASETS

(71) Applicant: Capital One Services, LLC, Mclean, VA (US)

(72) Inventors: Spandan FADNIS, Hoboken, NJ (US); David ROWAN, Plymouth Meeting, PA (US); Maninder Jeet SINGH, Newark, DE (US); Jashon CADE, Philadelphia, PA (US)

(21) Appl. No.: 18/433,204

(22) Filed: Feb. 5, 2024

(51) Int. Cl. G06Q 10/0639

(52) U.S. Cl. CPC G06Q 10/06395

(57) ABSTRACT

In some implementations, a system may obtain a first set of data quality rules for an incoming dataset and a second set of data quality rules for an outgoing dataset. The system may perform a first data quality validation check for the incoming dataset based on a comparison of data quality metrics associated with the incoming dataset and the first set of data quality rules, and may process the incoming dataset to generate an outgoing dataset based on the incoming dataset passing the first data quality validation check. The system may perform a second data quality validation check for an outgoing dataset based on a comparison of data quality metrics associated with the outgoing dataset and the second set of data quality rules, and may publish the outgoing dataset to a downstream data sink based on the outgoing dataset passing the second data quality validation check.

### BACKGROUND

“Data quality” generally refers to measures or metrics that represent the state of qualitative and/or quantitative data elements. Although there are various measures or metrics that may be used to indicate data quality (e.g., accuracy, completeness, consistency, validity, uniqueness, and/or timeliness, among other examples), data is typically considered high quality when the data is well-suited to serve a specific purpose (e.g., an intended use in operations, decision-making, and/or planning) and/or when the data correctly represents a real-world construct to which the data refers. In some cases, perspectives on data quality can differ, even with regard to the same dataset used for the same purpose. In such cases, data governance may be used to form agreed-upon definitions and standards for quality. For example, data governance may encompass people, processes, and/or information technology needed to consistently and properly handle data across an organization, with key focus areas including data availability, usability, consistency, integrity, security, and standard compliance.

### SUMMARY

Some implementations described herein relate to a system for self-service data quality control. The system may include one or more memories and one or more processors communicatively coupled to the one or more memories. The one or more processors may be configured to obtain a first set of user-defined data quality rules for an incoming dataset and a second set of user-defined data quality rules for an outgoing dataset. The one or more processors may be configured to perform a first data quality validation check for the incoming dataset based on a comparison of data quality metrics associated with the incoming dataset and the first set of user-defined data quality rules for the incoming dataset. The one or more processors may be configured to execute a data processing job to process the incoming dataset based on the incoming dataset passing the first data quality validation check, wherein the data processing job is executed to generate the outgoing dataset based on the incoming dataset. The one or more processors may be configured to perform a second data quality validation check for the outgoing dataset based on a comparison of data quality metrics associated with the outgoing dataset and the second set of user-defined data quality rules for the outgoing dataset. The one or more processors may be configured to publish the outgoing dataset to a downstream data sink based on the outgoing dataset passing the second data quality validation check.

Some implementations described herein relate to a method for data quality validation. The method may include receiving, by a data processing system, an incoming dataset from a data source. The method may include obtaining, by the data processing system, a set of user-defined data quality rules for the incoming dataset. The method may include performing, by the data processing system, a data quality validation check for the incoming dataset based on a comparison of data quality metrics associated with the incoming dataset and the set of user-defined data quality rules for the incoming dataset. The method may include aborting, by the data processing system, a data processing job to process the incoming dataset based on the incoming dataset failing the data quality validation check.

Some implementations described herein relate to a non-transitory computer-readable medium that stores a set of instructions. The set of instructions, when executed by one or more processors of a data processing system, may cause the data processing system to receive an incoming dataset from a data source. The set of instructions, when executed by one or more processors of the data processing system, may cause the data processing system to execute a data processing job to process the incoming dataset, wherein the data processing job is executed to generate an outgoing dataset based on the incoming dataset. The set of instructions, when executed by one or more processors of the data processing system, may cause the data processing system to obtain a set of user-defined data quality rules for the outgoing dataset. The set of instructions, when executed by one or more processors of the data processing system, may cause the data processing system to perform a data quality validation check for the outgoing dataset based on a comparison of data quality metrics associated with the outgoing dataset and the set of user-defined data quality rules for the outgoing dataset. The set of instructions, when executed by one or more processors of the data processing system, may cause the data processing system to send an alert to a client device to indicate that the outgoing dataset will not be published to a downstream data sink due to the outgoing dataset failing the data quality validation check.

### BRIEF DESCRIPTION OF THE DRAWINGS

FIGS. 1A-1C are diagrams of an example associated with self-service data quality control for incoming and outgoing datasets, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with self-service data quality control for incoming and outgoing datasets, in accordance with some embodiments of the present disclosure.

FIG. 4 is a flowchart of an example process associated with self-service data quality control for incoming and outgoing datasets, in accordance with some embodiments of the present disclosure.

### DETAILED DESCRIPTION

The following detailed description of example implementations refers to the accompanying drawings. The same reference numbers in different drawings may identify the same or similar elements.

Data quality is typically measured using one or more metrics that indicate how well-suited a dataset is to serve a specific purpose (e.g., a data analytics use case). For example, data quality metrics may include an accuracy metric to indicate whether the dataset reflects actual, real-world scenarios, a completeness metric to indicate whether the dataset effectively delivers all available values, a consistency metric to indicate whether the dataset includes uniform and/or non-conflicting values in different storage locations, a validity metric to indicate whether the dataset was collected according to defined business rules and parameters, conforms to a correct format, and/or falls within an expected range, a uniqueness metric to indicate whether there are any duplications or overlapping values across datasets, and/or a timeliness metric to indicate whether the dataset is available when required. In order to determine whether a given dataset is high quality (e.g., fit to serve an intended purpose), an organization may utilize data quality analysts to conduct data quality assessments in which individual data quality metrics are assessed and interpreted to derive intelligence related to the quality of the data within the organization.

In this way, organizations may identify and/or resolve data quality issues, such as duplicated data, incomplete data, inconsistent data, incorrect data, poorly defined data, poorly organized data, and/or poor data security. Furthermore, data quality rules are often an integral component of data governance, which includes processes to develop and establish a defined, agreed-upon set of rules and standards by which all data across an organization is governed. Effective data governance should harmonize data from various data sources, create and monitor data usage policies, and eliminate inconsistencies and inaccuracies that would otherwise negatively impact data analytics accuracy and/or regulatory compliance. However, monitoring data quality and/or managing data governance practices is associated with various challenges.

For example, a typical data processing system may execute one or more extract, transform, and load (ETL) pipelines to pull data from one or more (often heterogeneous) upstream data sources and post the data to one or more downstream data sinks. For example, an ETL pipeline may generally include processes to extract one or more incoming datasets (e.g., raw structured and/or unstructured data) from the upstream data sources (e.g., databases, cloud environments, on-premises environments, data warehouses, customer relationship management systems, and/or other data sources), transform the incoming dataset(s) into one or more outgoing datasets associated with a format compatible with a destination system (e.g., using data cleansing, standardization, deduplication, verification, sorting, and/or other techniques), and then load the outgoing dataset(s) to the downstream data sinks for user consumption or other use. However, data processing systems generally lack support for validating that the incoming datasets satisfy data quality standards in real-time prior to and/or while executing an ETL pipeline to process the incoming datasets, nor do data processing systems support validating that the outgoing datasets satisfy data quality standards prior to posting the outgoing datasets downstream. Rather, data processing systems are typically limited to identifying data quality issues only after the processed data has been consumed, which leads to poor quality data that may be inaccurate, misleading, unreliable, or otherwise ill-suited for an intended purpose.

Some implementations described herein relate to a data processing system that enables users to specify data quality rules that define guardrails for incoming datasets and outgoing datasets. For example, after obtaining an incoming dataset from one or more upstream data sources, the data processing system may perform an initial data quality validation check to determine whether the incoming dataset satisfies the applicable data quality rules for the incoming dataset. In cases where the incoming dataset fails the initial data quality validation check, the data processing system may abort an ETL pipeline or other data processing job for the incoming dataset, which conserves resources that would have otherwise been consumed by processing incoming datasets with data quality problems. Furthermore, the data processing system may send an alert to a client device to indicate that the data processing job was aborted, which allows a user of the client device to take appropriate action to resolve the data quality issues in the upstream data sources. Alternatively, in cases where the incoming dataset passes the initial data quality validation check, the data processing system may proceed with executing the data processing job to generate an outgoing dataset from the incoming dataset, and may then perform a second data quality validation check to determine whether the outgoing dataset satisfies the applicable data quality rules for the outgoing dataset. In cases where the outgoing dataset fails the second data quality validation check, the data processing system may discard the outgoing dataset, thereby avoiding publication of poor quality data to the downstream data sinks. Furthermore, the data processing system may send an alert to the client device to indicate that the outgoing dataset failed the data quality validation check, which allows the user to take appropriate action to reconfigure the data processing job or otherwise resolve issues in the data processing pipeline that may have contributed to the data quality issues in the outgoing dataset. Alternatively, in cases where the outgoing dataset passes the second data quality validation check, the data processing system may proceed with publishing the outgoing dataset to the downstream data sink(s).

In this way, by allowing users to define data quality rules to be applied against incoming and outgoing datasets, the data processing system described herein may conserve resources that would have otherwise been consumed by processing incoming datasets with data quality problems, avoid publishing poor quality data to the downstream data sinks, and provide users with the ability to quickly make changes to ensure that incoming and outgoing datasets are satisfying guidelines, requirements, or standards for an intended use case. Furthermore, validating incoming and outgoing datasets against user-defined data quality rules may offer tailored, adaptable, and fine-tuned measures to ensure data accuracy, relevancy, compliance, and continuous improvement within the intended use case. For example, because users typically understand data that the users consume and the related context better than generic rules, customized user-defined rules allow data quality checks to be tailored to specific requirements. Furthermore, because different industries, domains, organizations, or the like may have unique data quality needs, user-defined data quality rules may be used to establish criteria relevant to specific fields, regulations, business objectives, or data standards. In addition, user-defined data quality rules may offer other advantages over generic or predefined data quality rules, such as flexibility and agility to adapt data quality rules to evolving datasets, granular and precise data quality rules to target specific data elements, patterns, or anomalies, and/or continuous improvement by refining or creating new data quality rules to iteratively enhance data quality over time.

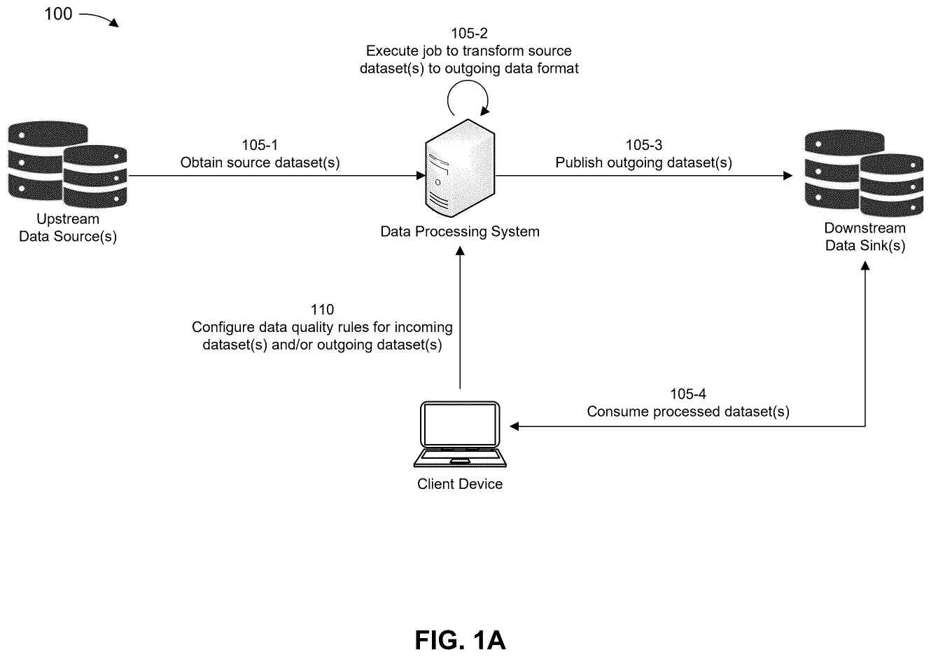

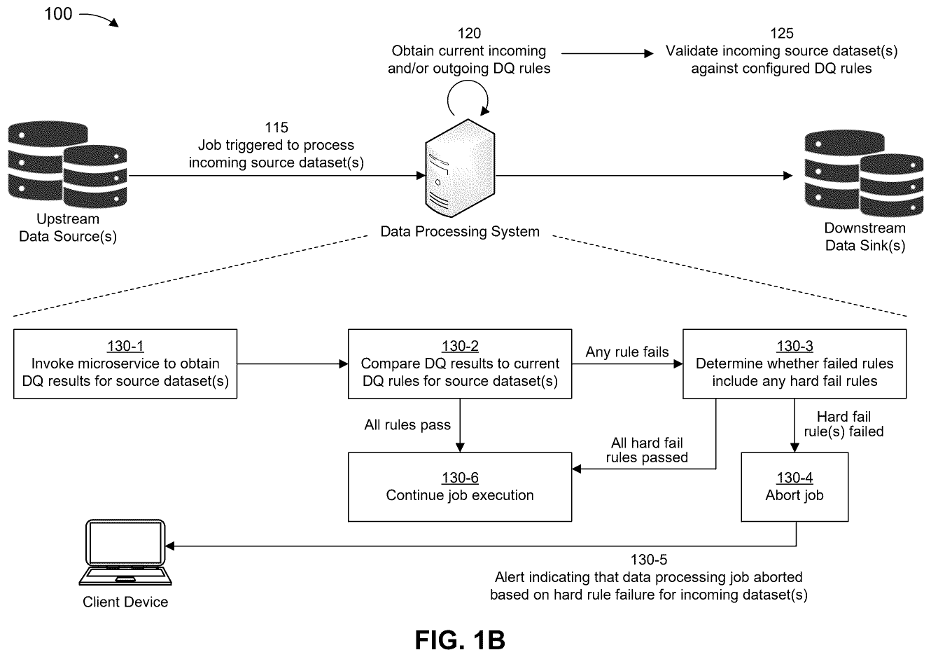

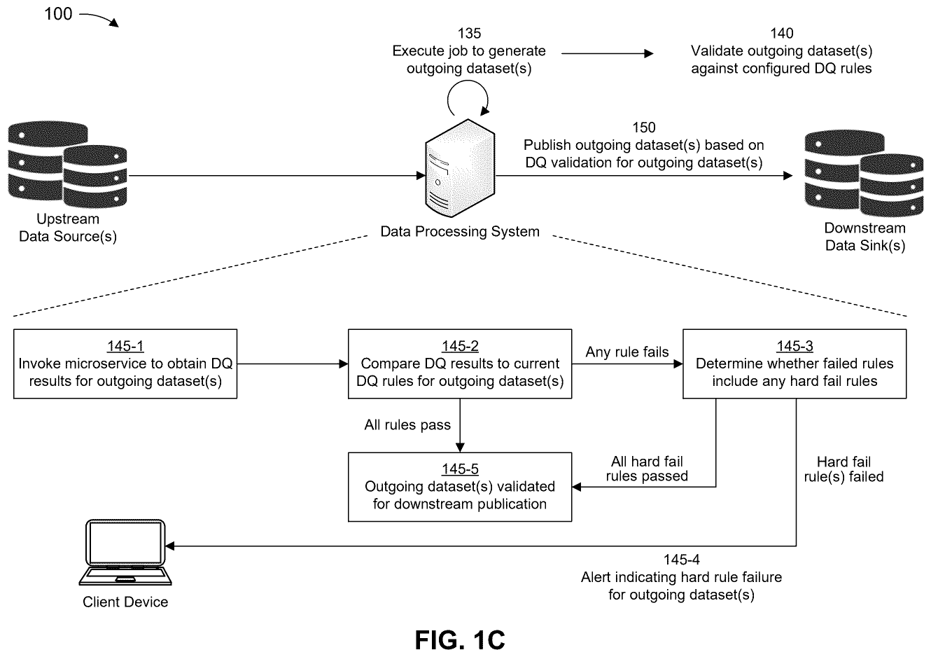

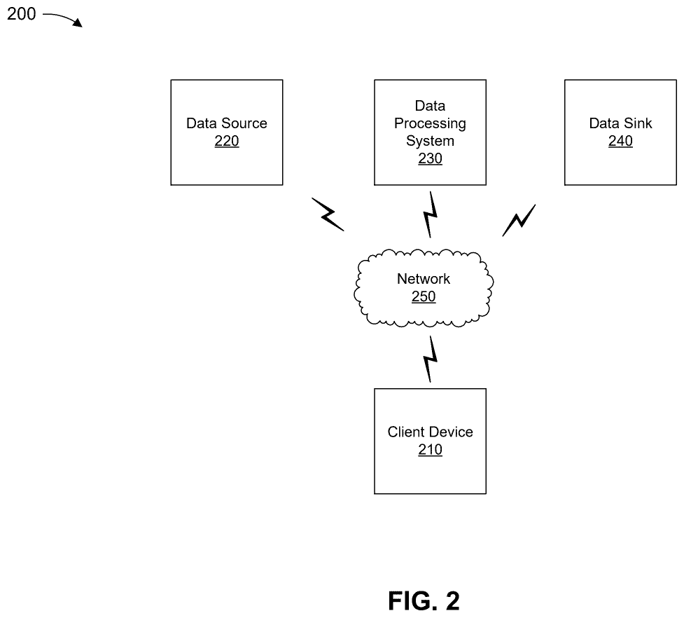

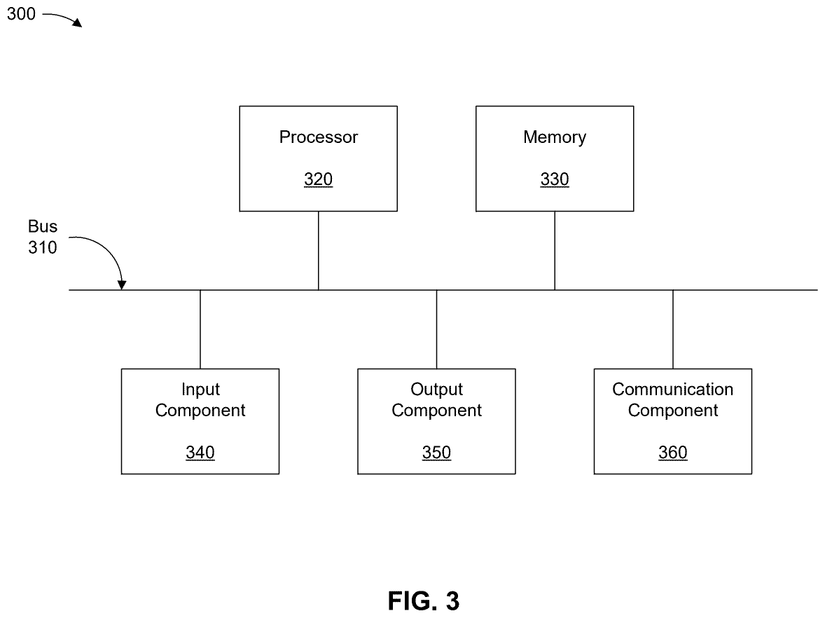

FIGS. 1A-1C are diagrams of an example 100 associated with self-service data quality control for incoming and outgoing datasets. As shown in FIGS. 1A-1C, example 100 includes a client device, one or more upstream data sources, a data processing system, and one or more downstream data sinks. The client device, the one or more upstream data sources, the data processing system, and the one or more downstream data sinks are described in more detail in connection with FIG. 2 and FIG. 3.

As shown in FIG. 1A, and by reference numbers 105-1, 105-2, 105-3, and 105-4, the data processing system may be configured to execute one or more data processing jobs, such as one or more ETL pipelines, and each data processing job may generally include one or more tasks that relate to extracting incoming datasets that include data records from source tables stored in the one or more upstream data sources, transforming the incoming datasets into an outgoing dataset associated with a target format, and loading the outgoing dataset into one or more tables in the one or more downstream data sinks.

For example, as shown by reference number 105-1, the data processing system may be configured to obtain one or more incoming datasets from the one or more upstream data sources, which may include structured and/or unstructured data stored in one or more data repositories, cloud environments, on-premises environments, application-specific data repositories, mobile devices, customer relationship management systems, or the like (e.g., including the query-friendly datasets generated by the event log management system). In some implementations, the upstream data source(s) may use heterogeneous and/or homogeneous data organizations and/or data formats to store data records in one or more source tables, and the extraction tasks may be configured to pull or otherwise obtain the incoming datasets from the upstream data sources and convert the incoming datasets into a data stream to enable subsequent transformation processing.

Accordingly, as further shown by reference number 105-2, the data processing system may be configured to perform one or more transformation tasks to apply rules, policies, and/or other functions to the incoming dataset obtained from the upstream data source(s) to prepare an outgoing dataset to be loaded into the downstream data sink(s). For example, in some implementations, the transformation tasks may include data cleansing to remove inconsistencies, resolving missing values, standardization to apply formatting rules to the extracted data records, deduplication to exclude or discard redundant data records, verification to remove unusable data records and/or flag anomalies in the content of the data records, sorting or ordering to organize the data records according to type or other criteria, joining data from multiple data sources, aggregating data to summarize multiple rows of data, and/or transposing or pivoting to convert multiple columns into multiple rows (or vice versa), among other examples. Furthermore, in some implementations, the transformation tasks may include one or more data validation tasks (e.g., verifying that transformed data records match an expected output). In such cases, a failed validation may result in a partial or full rejection of the data (or no rejection, depending on context), whereby all, some, or none of the data records may be handed over to a next stage in a data processing pipeline (e.g., loading tasks) depending on the outcome from the validation. Additionally, or alternatively, in a case of a failed data validation, one or more extraction and/or transformation tasks may be re-executed in an effort to correct issues that may have led to the failed data validation. In some implementations, the one or more data records may be stored in one or more staging tables or one or more intermediate sources while the transformation tasks are executed to transform the data records into the outgoing data set.

As further shown in FIG. 1A, and by reference number 105-3, the data processing system may be configured to perform one or more loading tasks to publish, to the downstream data sink(s), the outgoing dataset that was generated in the transformation stage of the data processing pipeline. For example, in some implementations, the loading tasks may be configured to overwrite existing data stored in the downstream data sink(s) with cumulative data and/or to insert new data in a historical form at periodic intervals. Additionally, or alternatively, the loading tasks may be configured to replace, append, and/or supplement data stored in the downstream data sink(s) in a manner that maintains a history and/or audit trail of changes to the data stored in the data sink(s). Furthermore, in some implementations, the loading tasks may be configured to load data records into the downstream data sink(s) all at once based on a full loading configuration and/or at scheduled intervals based on an incremental loading configuration (e.g., depending on available storage and/or processing resources, data volumes to be loaded, and/or other criteria). For example, a full loading configuration may indicate that all data passed from the transformation stage to the loading stage in the data processing pipeline is to be loaded into the downstream data sink(s) as new, unique records, which may be useful for in-depth research purposes. Alternatively, because a full loading configuration may result in exponential growth in a dataset that may be difficult to maintain (e.g., potentially causing a failure in the loading stage of the data processing pipeline), an incremental loading configuration may be used to compare incoming data to data already stored in the downstream data sink(s) and produce additional data records to be loaded into the downstream data sink(s) only for new and unique information. As further shown by reference number 105-4, a user of the client device may then consume one or more dataset(s) published to the downstream data sink(s) for any suitable data analytics use case.

In some cases, as described herein, a data processing pipeline may be associated with data quality problems, which may be caused by data quality issues associated with the incoming datasets that are obtained from the upstream data sources and/or data quality problems that arise in an outgoing dataset that is generated after the data processing job executes. Accordingly, as further shown in FIG. 1A, and by reference number 110, a user of the client device may interact with the data processing system to configure data quality rules for the incoming datasets that are obtained from the upstream data sources and/or data quality rules for the outgoing datasets that are generated by the data processing system. More particularly, as described herein, the user of the client device may define one or more data quality rules that specify checks or guardrails to be placed on the features of the incoming datasets and the outgoing datasets such that the data processing system can perform data quality validation checks to verify that the incoming and outgoing datasets satisfy certain data quality standards or requirements. For example, in some cases, the user-defined data quality rules may be associated with thresholds (e.g., an upper threshold and a lower threshold defining an expected range for a given data value). Additionally, or alternatively, the user-defined data quality rules may specify other suitable criteria that define requirements and/or an expected form for the features of the incoming and outgoing datasets.

For example, in some implementations, the user-defined data quality rules may be derived or based on business rules in order to specify one or more parameters to ensure that an incoming dataset, an outgoing dataset, or a data value or feature in an incoming or outgoing dataset satisfies data quality standards related to accuracy, completeness, consistency, uniqueness, or the like. For example, in some implementations, the user-defined data quality rules may include data element content rules that specify valid values, ranges, lengths, data types, patterns, and/or domains. Additionally, or alternatively, user-defined data element content rules may specify whether a given data element or feature is mandatory or optional (e.g., to evaluate completeness), and/or a reasonable distribution of values. Accordingly, the user-defined data element content rules may generally specify one or more parameters or constraints for a single data element or data feature, which may indicate whether the single data element or feature is valid or invalid. For example, in an incoming or outgoing dataset that includes customer information, a user-defined data element content rule may specify that the customer information is expected to have a fairly even distribution of birthdays, and that a much larger number of birthdays on a given day indicates a potential data quality issue.

Additionally, or alternatively, the user-defined data quality rules may include cross data element validation rules, which may be evaluated by inspecting values in multiple data elements (typically in a single dataset) to determine whether the data elements satisfy the applicable cross data element validation rule(s). For example, in some implementations, the cross data element validation rules may indicate one or more valid values that depend on other column values (e.g., a data value that indicates an otherwise valid location code may be deemed invalid if the location code does not fall within a range of values associated with a region code), may indicate one or more optional values that become mandatory when other column(s) contain certain data (e.g., an optional “collateral” field may become mandatory when a loan type column includes a “mortgage” or “vehicle” value), may indicate one or more mandatory values that become null when other column(s) contain certain data (e.g., a mandatory “agent name” field may be required to be empty if an “origination point” field is set to “web” to indicate that the customer applied for an insurance policy online), and/or cross-table validation rules that check columns and/or combinations of columns across tables (e.g., a “city” field and a “state” field in an address table may be cross-validated, to ensure that a state listed in the “state” field includes a city listed in the “city” field). Additionally, or alternatively, the user-defined data quality rules may include cross data file validation rules that check data elements and/or combinations of data elements across data files. For example, the cross data file validation rules may indicate one or more criteria for determining the mandatory presence of foreign key relationships (e.g., an account table may be required to have a value in a customer identifier column that matches a value in a customer identifier column of a customer table), for determining the optional presence of foreign key relationships, and/or for determining whether columns in different tables are consistent.

Accordingly, as described herein, the user-defined data quality rules may generally configure one or more requirements, criteria, expected forms, and/or other attributes for the incoming datasets that are obtained from the upstream data sources and for the outgoing datasets to be published to the downstream data sources. For example, as described herein, the user-defined data quality rules may include one or more data element content rules, one or more cross data element validation rules, and/or one or more cross data file validation rules that may be evaluated to determine whether one or more data values or data elements contained in the incoming and/or outgoing datasets conform to the applicable data quality standards for an intended data analytics use case. Additionally, or alternatively, the user-defined data quality rules may have other suitable forms or structures, such as domain rules that define lists of values that a given data element is allowed to have, domain pattern rules that define a list of patterns or regular expression syntaxes that a data element is allowed to conform to (e.g., a telephone number pattern may include ten consecutive digits or ten digits that are offset by parentheses and/or hyphens), domain range rules that define ranges of values that a data element is allowed to have, common format rules that define known common formats that are allowed for a data element, no nulls rules that specify that a given data element cannot have null values, unique key rules that define whether a data element or group of data elements are unique in a given data object, referential rules that define whether a data element or group of data elements is unique in a given data object, and/or custom data rules that apply structured query language (SQL) expressions or other parameters for determining whether a data element is valid (e.g., to ensure compatibility or consistency that enables use of the data set by downstream applications).

In some implementations, the user of the client device may configure separate sets of user-defined data quality rules for the incoming datasets and the outgoing datasets (e.g., based on differences in the requirements and/or expected forms of the incoming and outgoing datasets). Furthermore, in some implementations, the user-defined data quality rules may each be associated with a threshold (e.g., a percentage or ratio), where a user-defined data quality rule may be satisfied based on a quantity of data elements or features in an incoming or outgoing dataset satisfying the applicable threshold. Alternatively, the user-defined data quality rule may be violated based on a quantity of data elements or features in the incoming or outgoing dataset failing to satisfy the applicable threshold. Furthermore, in some implementations, each user-defined data quality rule may be associated with a parameter to classify the user-defined data quality rule according to a priority or importance of the user-defined data rule. For example, a user-defined data quality rule may be associated with a parameter to classify the user-defined data quality rule as a fault-tolerant rule, where a data processing job may be allowed to proceed despite an incoming dataset violating one or more fault-tolerant rules, and/or an outgoing dataset may be published downstream despite the outgoing dataset violating one or more fault-tolerant rules. Alternatively, a user-defined data quality rule may be associated with a parameter to classify the user-defined data quality rule as a hard fail rule, where a data processing job may be aborted if an incoming dataset violates one or more hard fail rules and/or an outgoing dataset may be discarded without being published downstream if the outgoing dataset violates one or more hard fail rules.

In this way, the user-defined data quality rules may place various guardrails on the datasets being processed and published, which may ensure that the data processing job is using datasets that satisfy data quality standards at every stage in the data processing pipeline, or alternatively alerting users when data quality standards do not meet user expectations that are memorialized in the user-defined data quality rules. Furthermore, allowing users to self-define the applicable data quality rules allows for automated decisioning within the data processing system based on data quality validation checks that are performed using the user-defined data quality rules and allows users to make changes with agility to ensure that incoming and outgoing datasets are satisfying data quality guidelines or requirements that are expected for a use case. Furthermore, in some implementations, the user-defined data quality rules may be specified without a code change to the data processing system, which allows the users to self-service the user-defined data quality rules (e.g., delete old data quality rules, define new data quality rules, or modify existing data quality rules) and permits the data quality validation checks to be scaled. For example, the ability to define and configure the user-defined data quality rules may be enabled with a light technology stack, where the data processing system provides a user interface or exposes an application program interface (API) to allow user-generated data quality rule files to be uploaded and stored by a microservice. Accordingly, as described herein, the data processing system may query the microservice to automatically obtain data quality results (e.g., data quality metrics) based on the current (most recent) version of the user-defined data quality rules when a data processing pipeline is triggered, thereby ensuring that any changes to the user-defined data quality rules are reflected in the data quality results before the data processing job is executed.

For example, as shown in FIG. 1B, and by reference number 115, the data processing system may obtain an incoming dataset from the upstream data source(s) when a data processing job to process the incoming dataset is triggered. For example, in some implementations, the data processing system may use batch processing techniques, stream processing techniques, and/or data replication techniques to obtain the incoming dataset so that the incoming dataset can be evaluated for compliance or non-compliance with a first set of user-defined data quality rules associated with the incoming dataset. For example, batch processing techniques may involve collecting the data associated with the incoming dataset in segments or batches that are then processed in bulk. In some implementations, the batch processing techniques may be used when the incoming dataset to be evaluated against the user-defined data quality rules has a large volume of data, as batch processing may provide a capability to handle complex transformations and/or cleansing operations on the incoming dataset prior to the data quality analysis. Additionally, or alternatively, the data processing system may use stream processing techniques for real-time data ingestion and data quality analysis, which may involve a continuous ingestion of data as the data is generated or stored by the upstream data source(s) (e.g., after being processed by one or more ETL pipelines and/or data cleansing techniques). Additionally, or alternatively, the data processing system may use data replication techniques to maintain synchronized copies of the incoming dataset across multiple systems or databases (e.g., to ensure data availability, reliability, and/or disaster recovery).

As further shown in FIG. 1B, and by reference number 120, the data processing system may then obtain a first set of user-defined data quality rules for the incoming dataset and a second set of user-defined data quality rules for an outgoing dataset to be generated from the incoming dataset. For example, as described herein, the current version of the user-defined data quality rulesets may be stored by a microservice, and the data processing system may query the microservice to obtain the current versions of the user-defined data quality rulesets for incoming and outgoing datasets when the data processing job is triggered. In this way, the data processing system may ensure that the most recent user-defined data quality rules are used to validate the incoming dataset and the outgoing dataset prior to performing the data processing job.

As further shown in FIG. 1B, and by reference number 125, the data processing system may then perform a first data quality validation check to validate the incoming dataset against the first set of user-defined data quality rules for the incoming dataset. For example, referring to FIG. 1B, reference numbers 130-1 through 130-6 correspond to a workflow that the data processing system performs to carry out the first data quality validation check for the incoming dataset. More particularly, as shown by reference number 130-1, the data processing system may invoke a microservice to obtain data quality metrics associated with the first set of user-defined data quality rules for the incoming dataset. For example, as described herein, the first set of user-defined data quality rules for the incoming dataset may generally include one or more data element content rules, one or more cross data element validation rules, one or more cross data file validation rules, domain rules, domain pattern rules, domain range rules, common format rules, no nulls rules, unique key rules, referential rules, and/or custom data rules, among other examples. Accordingly, the microservice invoked by the data processing system may evaluate the user-defined data quality rules for the incoming dataset to determine whether one or more data values or data elements contained in the incoming dataset conform to the applicable data quality standards for an intended data analytics use case.

Furthermore, in some implementations, the microservice may generate data quality metrics, such as percentages or ratios, that indicate a degree to which one or more data values or data elements contained in the incoming dataset conform to the data quality standards defined in the user-defined data quality rules. For example, in a use case where the incoming dataset is validated against a set of three user-defined data quality rules, the data quality metrics may indicate percentages, ratios, or other values to indicate a degree or extent to which the three user-defined data quality rules are satisfied by the data elements in the incoming dataset (e.g., {82%, 98%, 66%} to indicate that 82% of the data elements satisfied a first data quality rule, 98% of the data elements satisfied a second data quality rule, and 66% of the data elements satisfied a third data quality rule). Accordingly, as further shown by reference number 130-2, the data processing system may then compare the data quality metrics to the thresholds or other criteria associated with the user-defined data quality rules. For example, in the use case described herein, the first data quality rule may be associated with a threshold of 80%, the second data quality rule may be associated with a threshold of 90%, and the third data quality rule may be associated with a threshold of 75%. In this case, the data processing system may determine that the incoming dataset satisfies the first and second data quality rules (e.g., based on the data quality metric returned by the microservice equaling or exceeding the thresholds defined in the respective data quality rules), and that the incoming dataset fails to satisfy the third data quality rule (e.g., based on the data quality metric returned by the microservice failing to equal or exceed the threshold defined in the corresponding data quality rule).

As further shown by reference number 130-3, in cases where the incoming dataset fails to satisfy one or more of the user-defined data quality rules for the incoming dataset, the data processing system may determine whether any of the data quality rules that were not satisfied are configured as hard fail rules. For example, as described elsewhere herein, each data quality rule may be classified as a hard fail rule or a fault-tolerant rule, where the data processing job may be automatically aborted if the incoming dataset fails to satisfy a hard fail rule or allowed to proceed if the violated data quality rules are all fault-tolerant rules. Accordingly, as shown by reference number 130-4, the data processing system may abort the data processing job based on a determination that the incoming data set violated one or more user-defined data quality rules, and that at least one of the data quality rules that were violated is classified as a hard fail rule. For example, in the use case given above, where the third data quality rule was violated based on the 66% data quality metric failing to equal or exceed the 75% threshold, the data processing system may abort the data processing job if the third data quality rule is classified as a hard fail rule. In such cases, as shown by reference number 130-5, the data processing system may send an alert to the client device to indicate that the data processing job was aborted based on the hard rule failure. Furthermore, in some implementations, the alert may include a recommendation for the user of the client device to perform any remediation tasks for the datasets stored in the upstream data sources such that incoming datasets pass the data quality validation check in subsequent data processing runs. Additionally, or alternatively, in some implementations, the alert may provide the user of the client device with an option to override the automatic abort and allow the data processing job to proceed (e.g., with a warning that the outgoing dataset generated by the data processing job may have data quality issues).

Alternatively, as shown by reference number 130-6, the data processing system may execute the data processing job in cases where the incoming dataset satisfies all of the user-defined data quality rules for the incoming dataset and/or in cases where data quality rules that were violated are all classified as fault-tolerant rules (e.g., the incoming dataset satisfied all hard fail rules). For example, in the use case given above, where only the third data quality rule was violated, the data processing system may allow the data processing job to proceed if the third data quality rule is classified as a fault-tolerant rule and the first and second data quality rules are classified as hard fail rules. However, in such cases, the data processing system may still send an alert to the client device to indicate that one or more fault-tolerant rules were violated, and the alert may provide the user of the client device with an option to abort the data processing job. In some implementations, the alert may include a recommendation for the user of the client device to remediate the datasets stored in the upstream data sources such that incoming datasets also pass the fault-tolerant data quality rules in subsequent data processing runs.

Accordingly, as shown in FIG. 1C, and by reference number 135, the data processing system may execute the data processing job to generate an outgoing dataset from the incoming dataset based on the incoming dataset passing the data quality validation check associated with the user-defined data quality rules for the incoming dataset. For example, as described herein, the incoming dataset may pass the data quality validation check if all of the user-defined data quality rules for the incoming dataset are satisfied, or if all of the user-defined data quality rules that are violated for the incoming dataset are classified as fault-tolerant rules (e.g., provided that the user of the client device does not manually abort the data processing job due to the fault-tolerant rule failure(s)). Additionally, or alternatively, the data processing system may execute the data processing job to generate the outgoing dataset from the incoming dataset based on the user of the client device manually overriding an abort despite the incoming dataset failing the data quality validation check (e.g., due to violating one or more hard fail rules).

As further shown in FIG. 1C, and by reference number 140, the data processing system may then perform a second data quality validation check to validate the outgoing dataset against the second set of user-defined data quality rules for the outgoing dataset. For example, referring to FIG. 1C, reference numbers 145-1 through 145-5 correspond to a workflow that the data processing system performs to carry out the second data quality validation check for the outgoing dataset. More particularly, as shown by reference number 145-1, the data processing system may invoke the microservice to obtain data quality metrics associated with the second set of user-defined data quality rules for the outgoing dataset. For example, as described herein, the second set of user-defined data quality rules for the outgoing dataset may generally include one or more data element content rules, one or more cross data element validation rules, one or more cross data file validation rules, domain rules, domain pattern rules, domain range rules, common format rules, no nulls rules, unique key rules, referential rules, and/or custom data rules, among other examples. Accordingly, the microservice invoked by the data processing system may evaluate the user-defined data quality rules for the outgoing dataset to determine whether one or more data values or data elements contained in the outgoing dataset conform to the applicable data quality standards for an intended data analytics use case.

Furthermore, in a similar manner as the data quality validation check for the incoming dataset, the microservice may generate data quality metrics, such as percentages or ratios, that indicate a degree to which one or more data values or data elements contained in the outgoing dataset conform to the data quality standards defined in the user-defined data quality rules. For example, in a use case where the outgoing dataset is validated against a set of three user-defined data quality rules, the data quality metrics may indicate percentages, ratios, or other values to indicate a degree or extent to which the three user-defined data quality rules are satisfied by the data elements in the incoming dataset (e.g., {78%, 99%, 81%} to indicate that 78% of the data elements in the outgoing dataset satisfied a first data quality rule, 99% of the data elements in the outgoing dataset satisfied a second data quality rule, and 81% of the data elements in the outgoing dataset satisfied a third data quality rule). Accordingly, as further shown by reference number 145-2, the data processing system may then compare the data quality metrics to the thresholds or other criteria associated with the user-defined data quality rules. For example, in the use case described herein, the first data quality rule may be associated with a threshold of 80%, the second data quality rule may be associated with a threshold of 90%, and the third data quality rule may be associated with a threshold of 75%. In this case, the data processing system may determine that the outgoing dataset satisfies the second and third data quality rules (e.g., based on the 99% and 81% data quality metrics equaling or exceeding the 90% and 75% thresholds defined in the respective data quality rules). Furthermore, the data processing system may determine that the outgoing dataset fails to satisfy the first data quality rule (e.g., based on the 78% data quality metric returned by the microservice failing to equal or exceed the 80% threshold defined in the corresponding data quality rule).

As further shown by reference number 145-3, in cases where the outgoing dataset fails to satisfy one or more of the user-defined data quality rules for the outgoing dataset, the data processing system may determine whether any of the data quality rules that were not satisfied are configured as hard fail rules. For example, as described elsewhere herein, each data quality rule may be classified as a hard fail rule or a fault-tolerant rule, where the outgoing dataset may be discarded and not published downstream if the outgoing dataset fails to satisfy a hard fail rule or allowed to be published if the violated data quality rules are all fault-tolerant rules. Accordingly, as shown by reference number 145-4, the data processing system may send, to the client device, an alert indicating that the outgoing dataset is being discarded based on a determination that the outgoing data set violated one or more user-defined data quality rules, and that at least one of the data quality rules that were violated is classified as a hard fail rule. For example, in the use case given above, where the outgoing dataset violated the first data quality rule, the data processing system may discard the outgoing dataset if the first data quality rule is classified as a hard fail rule. In such cases, as shown by reference number 145-4, the data processing system may send the alert to the client device to indicate that the outgoing dataset was discarded based on the hard rule failure. In some implementations, the alert may further include a recommendation to perform one or more remediation tasks for the datasets stored in the upstream data sources and/or for the data processing logic employed for the data processing job such that outgoing datasets will pass the data quality validation check in subsequent data processing runs. Additionally, or alternatively, in some implementations, the alert may provide the user of the client device with an override option to publish the outgoing dataset to the downstream data sink despite the hard rule failure (e.g., with a warning that the published dataset may have data quality issues).

Alternatively, as shown by reference number 145-5, the data processing system may validate the outgoing dataset for downstream publication in cases where the outgoing dataset satisfies all of the user-defined data quality rules for the outgoing dataset and/or in cases where data quality rules that were violated are all classified as fault-tolerant rules (e.g., the outgoing dataset satisfied all hard fail rules). For example, in the use case given above, where only the first data quality rule was violated, the data processing system may validate the outgoing dataset for publication if the first data quality rule is classified as a fault-tolerant rule. In some implementations, in cases where the outgoing dataset violates one or more fault-tolerant rules, the data processing system may send an alert to the client device to indicate that one or more fault-tolerant rules were violated, and the alert may provide the user of the client device with an option to abort publication of the outgoing dataset. In some implementations, the alert may further include a recommendation for the user of the client device to remediate the datasets stored in the upstream data sources and/or the data processing logic employed for the data processing job such that outgoing datasets also pass the fault-tolerant data quality rules in subsequent data processing runs.

As shown by reference number 150, the outgoing dataset may then be published to the downstream data sink based on the outgoing dataset passing the second data quality validation check and/or based on the user enabling publication of the outgoing dataset despite the outgoing dataset failing the second data quality validation check (e.g., due to one or more hard fail rule violations). For example, as described herein, the data processing system may publish the outgoing dataset by overwriting existing data stored in the downstream data sink(s) with cumulative data and/or inserting new data in a historical form at periodic intervals. Additionally, or alternatively, the outgoing dataset may be published by replacing, appending, and/or supplementing data stored in the downstream data sink(s) in a manner that maintains a history and/or audit trail of changes to the data stored in the data sink(s). In any case, after the outgoing dataset has been published, the user of the client device may then access the outgoing dataset via the downstream data sink(s) for any suitable data analytics use case.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a client device 210, a data source 220, a data processing system 230, a data sink 240, and a network 250. Devices of the environment 200 may interconnect via wired connections, wireless connections, or a combination of wired and wireless connections.

The client device 210 may include one or more devices capable of receiving, generating, storing, processing, and/or providing information associated with self-service data quality control for incoming and outgoing datasets, as described elsewhere herein. For example, in some implementations, the client device 210 may be used to specify one or more data quality rules for incoming datasets that are obtained from the data source 220 and/or one or more outgoing datasets to be published to the data sink 240. Additionally, or alternatively, the client device 210 may receive alerts related to violations of one or more data quality rules and/or may access outgoing datasets that are published to the data sink 240, among other examples. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data source 220 may include one or more devices capable of receiving, generating, storing, processing, and/or providing information associated with self-service data quality control for incoming and outgoing datasets, as described elsewhere herein. The data source 220 may include a communication device and/or a computing device. For example, the data source 220 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 220 may communicate with one or more other devices of environment 200, as described elsewhere herein. As an example, the data source 220 may store incoming datasets that are obtained by the data processing system 230 and validated against one or more data quality rules that are specified using the client device 210, as described elsewhere herein.

The data processing system 230 may include one or more devices capable of receiving, generating, storing, processing, providing, and/or routing information associated with self-service data quality control for incoming and outgoing datasets, as described elsewhere herein. For example, in some implementations, the data processing system 230 may receive input from the client device 210 specifying one or more data quality rules for incoming and/or outgoing datasets, may validate incoming datasets obtained from the data source 220 against the data quality rules for the incoming datasets, execute a data processing job to generate an outgoing dataset based on an incoming dataset responsive to the incoming dataset passing a first data quality validation check associated with the data quality rules for the incoming dataset, and publish the outgoing dataset to the data sink 240 responsive to the outgoing dataset passing a second data quality validation check associated with the data quality rules for the outgoing dataset. Additionally, or alternatively, the data processing system 230 may abort the data processing job and send an alert to the client device 210 responsive to the incoming dataset failing the first data quality validation check and/or may send an alert to the client device 210 indicating that the outgoing dataset will not be published to the data sink 240 responsive to the outgoing dataset failing the second data quality validation check. The data processing system 230 may include a communication device and/or a computing device. For example, the data processing system 230 may include a server, such as an application server, a client server, a web server, a database server, a host server, a proxy server, a virtual server (e.g., executing on computing hardware), or a server in a cloud computing system. In some implementations, the data processing system 230 may include computing hardware used in a cloud computing environment.

The data sink 240 may include one or more devices capable of receiving, generating, storing, processing, and/or providing information associated with self-service data quality control for incoming and outgoing datasets, as described elsewhere herein. The data sink 240 may include a communication device and/or a computing device. For example, the data sink 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data sink 240 may communicate with one or more other devices of environment 200, as described elsewhere herein. As an example, the data sink 240 may store outgoing datasets that are published by the data processing system 230 responsive to the outgoing datasets being validated against one or more data quality rules that are specified for the outgoing datasets using the client device 210, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with self-service data quality control for incoming and outgoing datasets. The device 300 may correspond to the client device 210, the data source 220, the data processing system 230, and/or the data sink 240 described herein. In some implementations, the client device 210, the data source 220, the data processing system 230, and/or the data sink 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

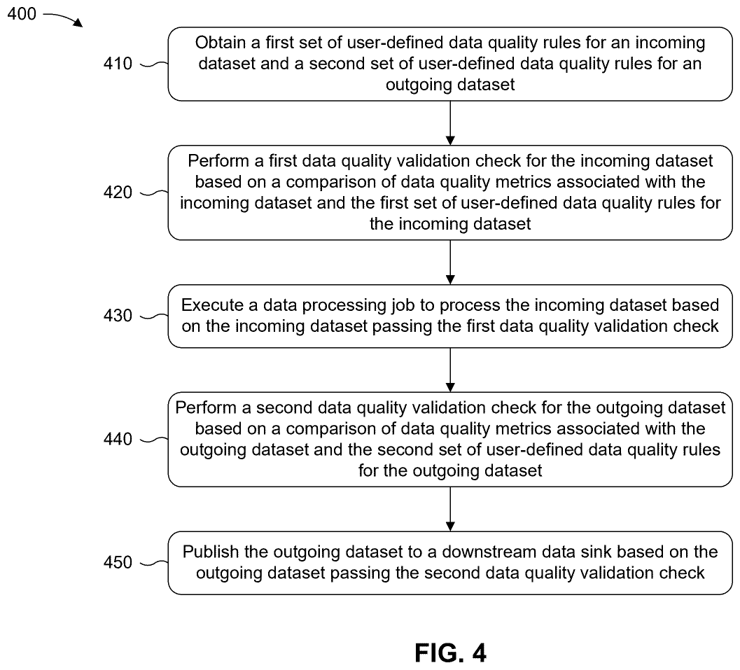

FIG. 4 is a flowchart of an example process 400 associated with self-service data quality control for incoming and outgoing datasets. In some implementations, one or more process blocks of FIG. 4 may be performed by the data processing system 230. In some implementations, one or more process blocks of FIG. 4 may be performed by another device or a group of devices separate from or including the data processing system 230, such as the client device 210. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a first set of user-defined data quality rules for an incoming dataset and a second set of user-defined data quality rules for an outgoing dataset (block 410). For example, the data processing system 230 (e.g., using processor 320 and/or memory 330) may obtain a first set of user-defined data quality rules for an incoming dataset and a second set of user-defined data quality rules for an outgoing dataset, as described above in connection with reference number 110 of FIG. 1A and reference number 120 of FIG. 1B. As an example, a user of a client device may interact with the data processing system to define data quality rules that are applied to incoming and outgoing datasets in order to specify one or more parameters to ensure that incoming datasets, outgoing dataset, and/or data values or features in incoming or outgoing datasets satisfy data quality standards related to accuracy, completeness, consistency, uniqueness, or the like. For example, different sets of user-defined data quality rules may be configured for incoming and outgoing datasets, and may generally include one or more data element content rules, cross data element validation rules, cross data file validation rules, domain rules, domain pattern rules, domain range rules, common format rules, no nulls rules, unique key rules, referential rules, and/or custom data rules, among other examples.

As further shown in FIG. 4, process 400 may include performing a first data quality validation check for the incoming dataset based on a comparison of data quality metrics associated with the incoming dataset and the first set of user-defined data quality rules for the incoming dataset (block 420). For example, the data processing system 230 (e.g., using processor 320 and/or memory 330) may perform a first data quality validation check for the incoming dataset based on a comparison of data quality metrics associated with the incoming dataset and the first set of user-defined data quality rules for the incoming dataset, as described above in connection with reference number 125 and reference numbers 130-1 through 130-6 of FIG. 1B. As an example, the data quality system may invoke a microservice that evaluates data elements, records, or other features of the incoming dataset against the criteria, requirements, conditions, or other parameters associated with the user-defined data quality rules for the incoming dataset, and the microservice may generate data quality metrics (e.g., percentages, ratios, or other values) that indicate a degree to which the data elements, records, or other features of the incoming dataset satisfy the user-defined data quality rules. Furthermore, each user-defined data quality rule may be associated with a threshold, where a user-defined data quality rule is violated (or fails) if the corresponding data quality metric fails to satisfy the threshold, or is satisfied (or passes) if the corresponding data quality metric satisfies the threshold.

As further shown in FIG. 4, process 400 may include executing a data processing job to process the incoming dataset based on the incoming dataset passing the first data quality validation check (block 430). In some implementations, the data processing job is executed to generate the outgoing dataset based on the incoming dataset. For example, the data processing system 230 (e.g., using processor 320 and/or memory 330) may execute a data processing job to process the incoming dataset based on the incoming dataset passing the first data quality validation check, wherein the data processing job is executed to generate the outgoing dataset based on the incoming dataset, as described above in connection with reference number 135 of FIG. 1C. As an example, the incoming dataset may pass the first data quality validation check if the incoming dataset satisfies all of the user-defined data quality rules for the incoming dataset or if all data quality rule violations are associated with fault-tolerant rules.

As further shown in FIG. 4, process 400 may include performing a second data quality validation check for the outgoing dataset based on a comparison of data quality metrics associated with the outgoing dataset and the second set of user-defined data quality rules for the outgoing dataset (block 440). For example, the data processing system 230 (e.g., using processor 320 and/or memory 330) may perform a second data quality validation check for the outgoing dataset based on a comparison of data quality metrics associated with the outgoing dataset and the second set of user-defined data quality rules for the outgoing dataset, as described above in connection with reference number 140 and reference numbers 145-1 through 145-4 of FIG. 1C. As an example, the data quality system may invoke the microservice to generate data quality metrics (e.g., percentages, ratios, or other values) that indicate a degree to which the data elements, records, or other features of the outgoing dataset satisfy the user-defined data quality rules for the outgoing dataset. Furthermore, like the data quality rules associated with the incoming dataset, each user-defined data quality rule for the outgoing dataset may be associated with a threshold, where a user-defined data quality rule is violated (or fails) if the corresponding data quality metric fails to satisfy the threshold, or is satisfied (or passes) if the corresponding data quality metric satisfies the threshold.

As further shown in FIG. 4, process 400 may include publishing the outgoing dataset to a downstream data sink based on the outgoing dataset passing the second data quality validation check (block 450). For example, the data processing system 230 (e.g., using processor 320 and/or memory 330) may publish the outgoing dataset to a downstream data sink based on the outgoing dataset passing the second data quality validation check, as described above in connection with reference number 150 of FIG. 1C. As an example, the outgoing dataset may pass the second data quality validation check such that the outgoing dataset is published to the downstream data sink if the outgoing dataset satisfies all of the user-defined data quality rules for the outgoing dataset or if all data quality rule violations for the outgoing dataset are associated with fault-tolerant rules.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for self-service data quality control, the system comprising:
one or more memories; and
one or more processors, communicatively coupled to the one or more memories, configured to:
obtain a first set of user-defined data quality rules for an incoming dataset and a second set of user-defined data quality rules for an outgoing dataset;
perform a first data quality validation check for the incoming dataset based on a comparison of data quality metrics associated with the incoming dataset and the first set of user-defined data quality rules for the incoming dataset;
execute a data processing job to process the incoming dataset based on the incoming dataset passing the first data quality validation check,
wherein the data processing job is executed to generate the outgoing dataset based on the incoming dataset;
perform a second data quality validation check for the outgoing dataset based on a comparison of data quality metrics associated with the outgoing dataset and the second set of user-defined data quality rules for the outgoing dataset; and
publish the outgoing dataset to a downstream data sink based on the outgoing dataset passing the second data quality validation check.

2. The system of claim 1, wherein the first set of user-defined data quality rules for the incoming dataset includes one or more hard fail rules and one or more fault-tolerant rules.

3. The system of claim 2, wherein the one or more processors, to perform the first data quality validation check for the incoming dataset, are configured to:
determine that the data quality metrics associated with the incoming dataset failed to satisfy one or more data quality rules among the first set of user-defined data quality rules; and
determine that the incoming dataset passed the first data quality validation check based on the one or more failed data quality rules each being a fault-tolerant rule.

4. The system of claim 1, wherein the one or more processors, to perform the first data quality validation check for the incoming dataset, are configured to:
determine that the incoming dataset passed the first data quality validation check based on the data quality metrics associated with the incoming dataset satisfying one or more criteria associated with each data quality rule in the first set of user-defined data quality rules.

5. The system of claim 1, wherein the second set of user-defined data quality rules for the outgoing dataset includes one or more hard fail rules and one or more fault-tolerant rules.

6. The system of claim 5, wherein the one or more processors, to perform the second data quality validation check for the outgoing dataset, are configured to:
determine that the data quality metrics associated with the outgoing dataset failed to satisfy one or more data quality rules among the second set of user-defined data quality rules; and
determine that the outgoing dataset passed the second data quality validation check based on the one or more failed data quality rules each being a fault-tolerant rule.

7. The system of claim 1, wherein the one or more processors, to perform the second data quality validation check for the outgoing dataset, are configured to:
determine that the outgoing dataset passed the second data quality validation check based on the data quality metrics associated with the outgoing dataset satisfying one or more criteria associated with each data quality rule in the second set of user-defined data quality rules.

8. The system of claim 1, wherein the one or more processors are configured to obtain a current version of the first set of user-defined data quality rules for the incoming dataset and a current version of the second set of user-defined data quality rules for the outgoing dataset responsive to receiving the incoming dataset from an upstream data source.

9. The system of claim 1, wherein the one or more processors are further configured to:
invoke a microservice to obtain the data quality metrics associated with the incoming dataset and the data quality metrics associated with the outgoing dataset.

10. A method for data quality validation, comprising:
receiving, by a data processing system, an incoming dataset from a data source;
obtaining, by the data processing system, a set of user-defined data quality rules for the incoming dataset;
performing, by the data processing system, a data quality validation check for the incoming dataset based on a comparison of data quality metrics associated with the incoming dataset and the set of user-defined data quality rules for the incoming dataset; and
aborting, by the data processing system, a data processing job to process the incoming dataset based on the incoming dataset failing the data quality validation check.

11. The method of claim 10, further comprising:
sending an alert to a client device to indicate that the data processing job was aborted due to the incoming dataset failing the data quality validation check.

12. The method of claim 10, wherein the set of user-defined data quality rules for the incoming dataset include one or more hard fail rules and one or more fault-tolerant rules.

13. The method of claim 12, wherein performing the data quality validation check for the incoming dataset comprises:
determining that the data quality metrics associated with the incoming dataset failed to satisfy one or more data quality rules among the set of user-defined data quality rules; and
determining that the incoming dataset failed the data quality validation check based on the one or more data quality rules that failed including at least one hard fail rule.

14. The method of claim 10, comprising obtaining a current version of the set of user-defined data quality rules for the incoming dataset responsive to receiving the incoming dataset from the data source.

15. The method of claim 10, further comprising:
invoking a microservice to obtain the data quality metrics associated with the incoming dataset.

16. A non-transitory computer-readable medium storing a set of instructions, the set of instructions comprising:
one or more instructions that, when executed by one or more processors of a data processing system, cause the data processing system to:
receive an incoming dataset from a data source;
execute a data processing job to process the incoming dataset,
wherein the data processing job is executed to generate an outgoing dataset based on the incoming dataset;
obtain a set of user-defined data quality rules for the outgoing dataset;
perform a data quality validation check for the outgoing dataset based on a comparison of data quality metrics associated with the outgoing dataset and the set of user-defined data quality rules for the outgoing dataset; and
send an alert to a client device to indicate that the outgoing dataset will not be published to a downstream data sink due to the outgoing dataset failing the data quality validation check.

17. The non-transitory computer-readable medium of claim 16, wherein the set of user-defined data quality rules for the outgoing dataset includes one or more hard fail rules and one or more fault-tolerant rules.

18. The non-transitory computer-readable medium of claim 17, wherein the one or more instructions, that cause the data processing system to perform the data quality validation check for the outgoing dataset, cause the data processing system to:
determine that the data quality metrics associated with the outgoing dataset failed one or more data quality rules among the set of user-defined data quality rules; and
determine that the outgoing dataset failed the data quality validation check based on the one or more data quality rules that failed including at least one hard fail rule.

19. The non-transitory computer-readable medium of claim 16, wherein the one or more instructions further cause the data processing system to obtain a current version of the set of user-defined data quality rules for the outgoing dataset responsive to receiving the incoming dataset from the data source.

20. The non-transitory computer-readable medium of claim 16, wherein the one or more instructions further cause the data processing system to:
invoke a microservice to obtain the data quality metrics associated with the outgoing dataset.
